(19) United States
(12) Patent Application Publication
(10) Pub. No.: US 2006/0272140 A1
(43) Pub. Date: Dec. 7, 2006

(54) Positioning pin removing tool for vehicles

(76) Inventor: Hsin Fa Kang, Tainan City (TW)

Correspondence Address: Kang Hsin Fa, P.O. BOX 90, Tainan City, 70499, TW

(21) Appl. No.: 11/140,931

(22) Filed: Jun. 1, 2005

(51) Int. Cl. B25B 27/14

(52) U.S. Cl. 29/278

(57) ABSTRACT

A positioning pin removing tool includes a clamping member, a sleeve, a tightening nut, and a short connecting rod. The clamping member has a center hole formed in a lower portion, a vertical slot in the wall defining the center hole of the lower portion, and a center clamping hole for clamping a positioning pin, and an outer tapered surface and plural vertical grooved openings in the upper portion. The sleeve is fitted around the clamping member, having a projecting point to fit in the slot of the clamping member. The short connecting rod threadably engages the tightening nut and with the clamping member. After the clamping member is aligned to and clamps a positioning pin, the short connecting rod is connected with an elongate connecting rod together with a hammering member of a conventional positioning-pin removing tool, for removing the positioning pin.

### BACKGROUND OF THE INVENTION

1. Field of the Invention

This invention relates to a positioning pin removing tool for vehicles, particularly to one convenient to align a clamping member to a positioning pin for carrying out removing it.

2. Description of the Prior Art

Many positioning pins are used in components of a common vehicle, such as for shafts of the transmitting gears, so special tools are necessary for taking off those positioning pins first so as to take off other components. FIGS. 1 and 2 show a conventional positioning pin removing tool 1, which includes a clamping member 11, a sleeve 12, a tightening nut 13 provided with female threads 130, a hammering member 14 with a center hole 140, and an elongate rod 15.

The clamping member 11 has a center hole 110 with female threads formed in a lower portion, a vertical slot 111 formed in the wall defining the hole 110, a clamping through hole 112 in the center, a tapered surface 113 in an upper portion, and plural vertical grooved openings 114 formed spaced apart in the upper portion and communicating with the clamping hole 112.

The sleeve 12 fits around the clamping member 11, having a projecting point 120 on an outer surface to fit movably in the slot 111 of the clamping member 11.

The elongate rod 15 has male threads 150 on a lower portion, and a grip 151 formed on an upper portion, extending through the hammering member 14, threadably engaging with the tightening nut 13 and with the clamping member 11.

In using, the clamping hole 112 of the clamping member 11 is fitted around a positioning pin (A) of a vehicle, and the tightening nut 13 is screwed down, forcing the sleeve 12 move down along the tapered surface 113 of the clamping member 11 so that the clamping hole 112 may fit tightly around the positioning pin (A). Then the hammering member 14 is used to strike against the grip 151 of the elongate rod 15, pulling out the positioning pin (A), not breaking the positioning pin (A) at all.

However, the conventional removing tool 1 is very long, often difficult to align the tool 1 to the positioning pin (A) for removing it. In addition, the tool 1 is very heavy, not easy to handle.

### SUMMARY OF THE INVENTION

The purpose of the invention is to offer a positioning pin removing tool for vehicles possible to conveniently align a clamping member to a positioning pin and clamp it for removing.

The main feature of the invention is provision of a clamping member, a sleeve, a tightening nut and a short connecting rod. The clamping member has a center clamping hole in an upper portion, a center large hole in a lower portion, female threads formed in the center large hole, a vertical slot in the wall defining the center large hole in the lower portion, an outer tapered surface on an upper portion, plural vertical grooved openings spaced apart in the upper portion and communicating with the center clamping hole. The sleeve is fitted around the clamping member and having a projecting point on an outer surface to fit movably in the vertical slot of the clamping member. The short connecting rod threadably engages the tightening nut and the clamping member. The short connecting rod has male threads in a lower portion and female threads in an upper portion.

### BRIEF DESCRIPTION OF DRAWINGS

This invention will be better understood by referring to the accompanying drawings, wherein:

FIG. 1 is an exploded perspective view of a conventional positioning pin removing tool for vehicles;

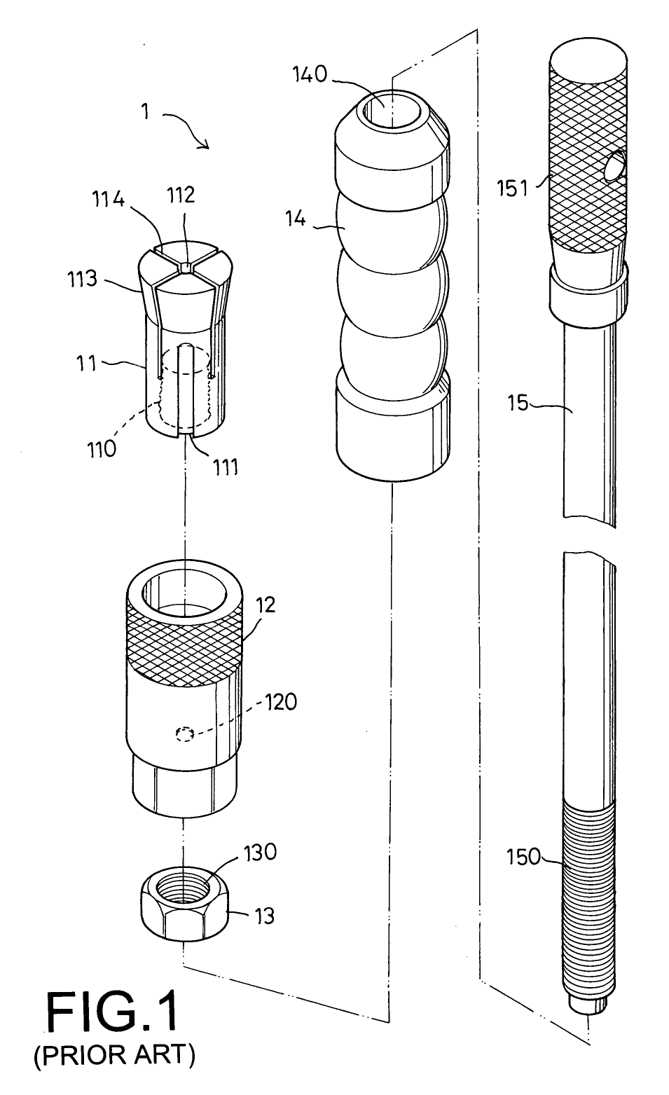

FIG. 2 is a perspective view of the conventional positioning pin removing tool for vehicles;

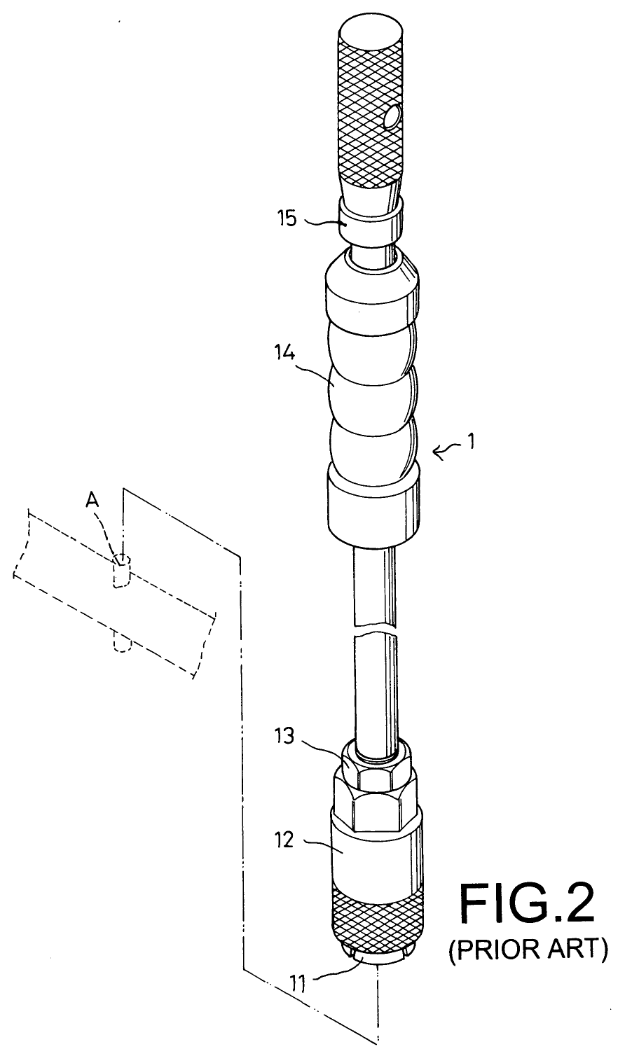

FIG. 3 is an exploded perspective view of a positioning pin removing tool for vehicles in the present invention;

FIG. 4 is a perspective view of a clamping member and a short connecting rod in the present invention;

FIG. 5 is a side cross-sectional view of the positioning pin removing tool being removing a positioning pin in the present invention; and,

FIG. 6 is another cross-sectional view of the positioning pin removing tool being removing a positioning pin in the present invention.

### DETAILED DESCRIPTION OF THE PREFERRED EMBODIMENT

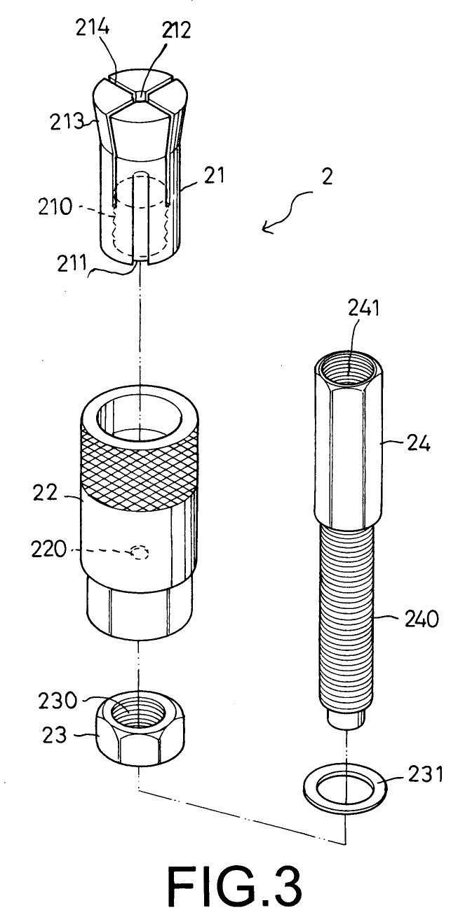

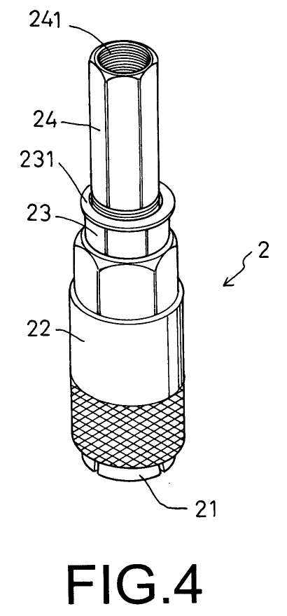

A preferred embodiment of a positioning pin removing tool 2 for vehicles in the present invention, as shown in FIGS. 3 and 4, includes a clamping member 21, a sleeve 22, a tightening nut 23 and a short connecting rod 24 as main components combined together.

The clamping member 21 is provided with a center hole 210 with female threads formed in a lower portion and opening to the lower end, a vertical slot 211 formed in the wall defining the center hole 210, a center clamping hole 212 formed in an upper portion, a tapered outer surface 213 also formed in the upper portion, and plural vertical grooves openings 214 spaced apart equidistantly and communicating with the center clamping hole 212.

The sleeve 22 is fitted movably around the clamping member 21, having a projecting point 220 on an inner surface to fit movably in the slot 211 of the clamping member 21.

The tightening nut 23 has female threads 230 to screw with the connecting rod 24.

The short connecting rod 24 has male threads 240 in a lower portion to screw with the female threads 230 of the tightening member 23 and further with the female threads of the hole 210 of the clamping member 21 through a washer 231. The short connecting rod 24 further has female threads 241 in an upper portion for engaging the hammering member 14 of the conventional positioning-pin removing tool connected with the elongate rod of the conventional tool so as to perform pulling work of a positioning pin.

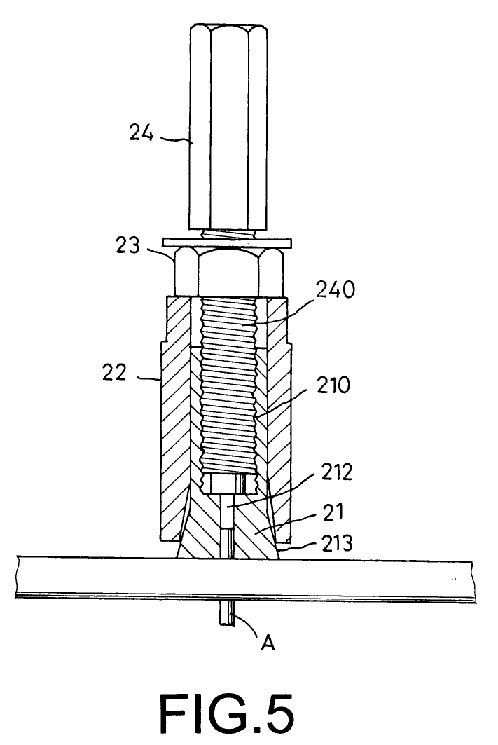

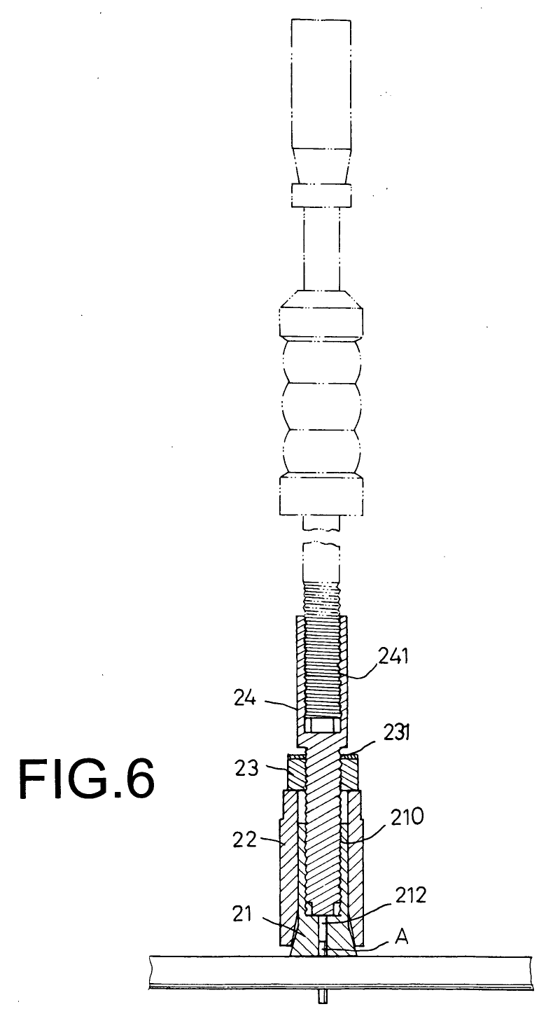

In using, referring to FIGS. 3 to 6, firstly, put the sleeve 22 around the clamping member 21, with the projecting point 220 fitting in the slot 211 of the clamping member 21. Next, the short connecting rod 24 is screwed with the tightening nut 23, with the washer 231 fitted between them, and subsequently the male threads 240 is screwed with the female threads of the center hole 210, with the clamping center hole 212 aligned to and fitted around the upper end of the positioning pin (A). Then the tightening nut 23 is screwed down to force the sleeve 22 move down slowly and along the tapered surface 213 of the clamping member 21 so that the clamping hole 212 may tightly clamp the positioning pin (A). Then the elongate rod 15 of the conventional positioning-pin removing tool is fitted around the hammering member 14 of the conventional tool, and then the male threads 150 of the elongate rod 15 is engaged with the female threads 241 of the short connecting rod 24. Therefore, the hammering member 14 is hammered to move toward the grip 151 of the elongate rod 15 for pulling out the positioning pin (A).

As the clamping member 21 threadably combined with the short connecting rod 24 can be correctly and easily aligned to the positioning pin (A), and after the clamping member 21 clamps the positioning pin (A), the elongate rod 15 together with the hammering member 14 can be connected with the short connecting rod 24, convenient to handle the removing tool 2.

While the preferred embodiment of the invention has been described above, it will be recognized and understood that various modifications may be made therein and the appended claims are intended to cover all the modifications that may fall within the spirit and scope of the invention.

What is claimed is:

1. A positioning pin removing tool for vehicles, said tool comprising:
A clamping member provided with a clamping center hole in an upper portion and a center hole in a lower portion, said center hole having an opening in a lower end and female threads, said clamping member further having a vertical slot in the wall defining said center hole in the lower portion and an outer tapered surface in the upper portion and plural vertical grooved openings spaced apart equidistantly in the upper portion, said vertical grooved openings all communicating with said center clamping hole;
A sleeve fitting around said clamping member and having a projecting point on its inner wall to fit movably in said vertical slot of said clamping member;
A short connecting rod provided with male threads in a lower portion and female threads in an upper portion;
A tightening nut threadably engaging with said male threads of said short connecting rod;
Said clamping member threadably engaging with said connecting rod and possible to be conveniently aligned to a positioning pin of a vehicle, said clamping member tightly clamping said positioning pin, a hammering member connected together with an elongate rod used in a conventional positioning pin removing tool, said hammering member with said elongate rod threadably engaged with said short connecting rod for carrying out removing said positioning pin.
